(19) United States
(12) Patent Application Publication
(10) Pub. No.: US 2015/0164219 A1
(43) Pub. Date: Jun. 18, 2015

(54) TABLE LEG SYSTEM

(71) Applicant: NOWY STYL SPÓLKA Z O.O., KROSNO (PL)

(72) Inventor: Jens Korte, Hamburg (DE)

(73) Assignee: NOWY STYL SPÓLKA Z O.O., KROSNO (PL)

(21) Appl. No.: 14/413,825

(22) PCT Filed: Nov. 26, 2012
(86) PCT No.: PCT/PL2012/000128

§ 371 Date: Jan. 9, 2015

(30) Foreign Application Priority Data
Jul. 9, 2012 (PL) P-399857

(51) Int. Cl. A47B 13/00; F16B 12/44

(52) U.S. Cl. CPC A47B 13/003; F16B 12/44; A47B 2013/006

(57) ABSTRACT

The table leg system meant for being blocked against the tabletop or against a set of tables combined in modules, characteristic in the fact that the upper end of the table leg system is equipped with a case (1) over the assembly mechanism, perpendicular to the longitudinal axis of the leg to which the casing (24) with formed hallows (27) is screwed from the side of the tabletop. It is also characteristic in the fact that in the case (1) there are the levers' (3) and (4) rotating axes in relation to the case (1) itself, and the levers (3) and (4) are on both ends terminated with fastening, blocking tangs (5) and (6) perpendicular to the lever (3) and (4) and one of the ends of each of the levers is attached to an oscillating hinged connector (7) which has a pivot handle (8) installed at the other end.

The object of the invention consists of a table leg system meant for being blocked against the tabletop or against a set of tables combined in modules.

Patent specification no. PL 194803 presents a particular frame: the basis of a set of office tables which contains at least two sets of legs connected with perforated profiles and is equipped with tubular legs attached permanently and solidly in pairs with a groove, square profile. There are connection blocks with transverse ports set in this profile, and the blocks are connected with the table frame's longitudinal profiles, the ends of which hold bolts which enter the transverse ports of the blocks. The bolts have transverse conic grooves to fit the cone point screws which block the movement of the frame profiles against the closed profile that connects the legs.

There are also to be found descriptions of bases made up of pairs of legs attached to the frame profiles with furniture connectors, e.g. off-center connectors, such as presented in the specification DE 41 10 809, or screw fasteners, as in the specification DE 30 39 421. These connectors require complicated off-center or screw elements, or else expansion clips let into a tube, as described in specification EP 403 852.

Patent specification EP 1915923 demonstrates, in turn, a backing plate which is fastened to the tabletop, and the leg of the system is equipped with a sliding key which enters the groove and becomes wedged in the backing plate.

The above-mentioned examples present solutions which are complicated, time-consuming, and require acute precision in order for one to achieve a stable, clearance-free connection.

The purpose of the invention has been to create a table leg system attached to the tabletop with the use of simple connectors which could be produced with simple and low-cost technologies, as well as a table leg which would be the connector of two tabletops at the same time.

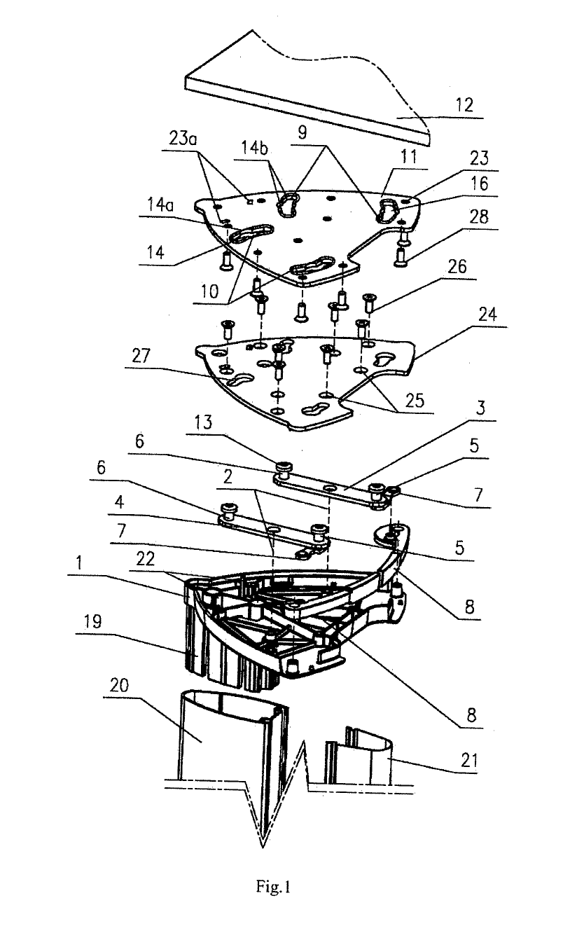

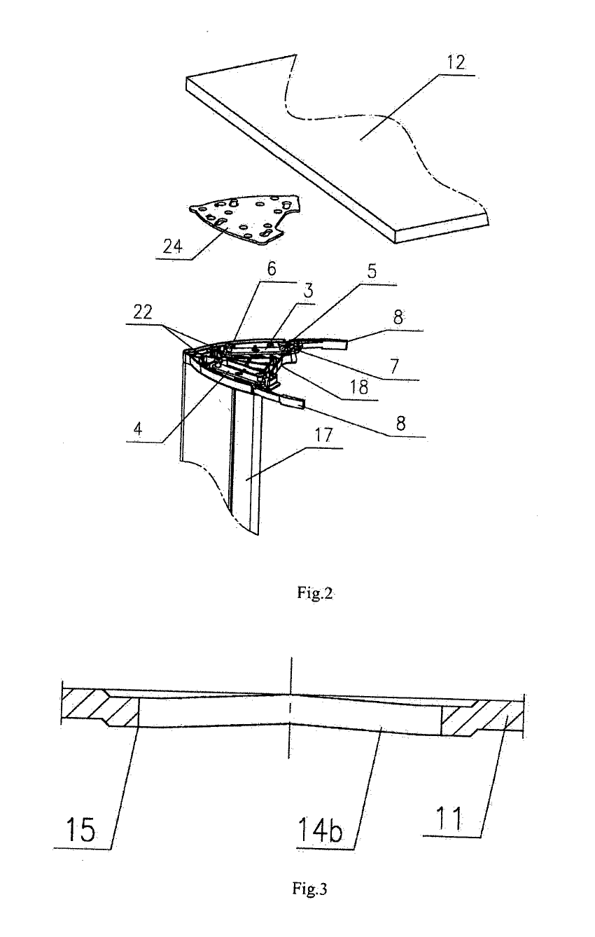

This purpose has been achieved in the invented solution, where the table leg system meant for being blocked against the tabletop or against a set of tables combined in modules, possesses a case over the assembly mechanism, which is perpendicular to the longitudinal axis of the leg to which the casing is screwed from the side of the tabletop. The casing has formed grooves and is attached through ports with the help of screws. In the case there are rotation axes of the case's little levers, and the levers are terminated on both ends with fastening, blocking tangs perpendicular to the levers. One of the ends of the lever is attached to an oscillating hinged connector, which has a pivot handle installed at the other end. The fastening, blocking tangs cooperate with the pairs of formed grooves in the plate fixed to the underside of the tabletop/tabletops. The pairs of the formed grooves are made up of the right and the left groove and exist in the form of a port connected on both sides along a curve with narrowed extensions where blocking ribs are to be found. The grooves have a common longitudinal axis which consists of a curve of a radius equivalent to the radius set out by the fastening, blocking tangs of the levers turned on the axis. The pairs of formed hollows are located symmetrically relative to the symmetry axis of the plate, and the axes going through the ports run at a 45-degree angle to one another. The fastening, blocking tangs are equipped with a flange in their upper part which corresponds to the port in the plate. The casing from the side of the tabletop is of an outward shape which corresponds with the shape of the case and fits within the case. The casing has a groove located underneath the free ends of the handles in the position of the table leg being attached to the tabletop, whereas the curves of the handles in this position form a common ridge with the ridge of the casing located by the groove. The casing has a perpendicular, springy lobe on the same side as the entry into the profile of the leg, and the leg is made up of a profile and an attached casing for wires. On the side of the tabletop, the casing has two locking lips which base the table leg system in relation to the tabletop through ports made in the plate. The advantage of the above solution is a fast, solid and secure assembly of the table without the need for additional elements or tools. Fastening the leg is quick and stable and can be performed in any kind of conditions and circumstances by unskilled persons. The solution assures an esthetic shape of the leg-tabletop connection. An example of how a furniture frame is made in accordance with the invention has been presented in the illustrations below, where FIG. 1 is a three-dimensional view of the table leg system in the state of non-assembly; FIG. 2 presents a three-dimensional view of the table leg system in a semi-assembled state; FIG. 3 shows a three-dimensional view of the formed groove in the backing plate; FIG. 4 is a view from below the assembled table leg system, with the backing plates unblocked; FIG. 5 gives a view of the table leg system as attached to two tabletops. The description to the figures is given below.

The table leg system consists of a case 1 which holds the mechanism of the leg's subassembly and the plate 11 fixed to the tabletop 12. The tabletop 12 in the spot where the backing plate 11 is screwed to it has a furrowing of a depth corresponding to that of the backing plate 11. Additionally in the place of the sliding of the blocking tang 5 and 6 in the backing plate 11 in the pair of grooves 9 and 10 there is an extra furrow which is a reflection of the flange 13 of the blocking tang 5 and 6. To a tabletop 12 of such making, the backing plate 11 is screwed through the ports 23 with the use of screws 28. In the case 1 on the levers 3 and 4 are fixed the blocking tangs 5 and 6 whose upper parts are terminated with a flange 13 of a diameter which corresponds the groove 27 of the casing 24 as well as the port 14a in the backing plate 11 and the furrowing in the tabletop 12. To the extremity of each of the levers 3 and 4 a connector 7 is attached in an oscillating way, and to the other end of the connector 7 a handle 8 is attached, also in an oscillating way. The movement of the other end of the handle 8 results in the movement of the blocking tangs 5 and 6 around the periphery, in relation to the rotation axis 2 of the lever, and at the same time in relation to the fixing point of each of the levers 3 and 4. The whole mechanism is covered from above with a casing 24 which also possesses assembly ports 25, through which it is fixed to the case 1 with screws 26 and it has formed grooves 27 in which the blocking tangs 5 and 6 slide. The case 1 is, on the side of the leg 17, terminated with a perpendicular, springy lobe 19 which corresponds with the shape of the leg; it is upon this lobe that the leg 17 is fixed. The leg 17 consists of a main profile 20 and casing 21 for wires which is attached in a snap-on way at the side. Such a subassembly is brought to the tabletop 12 in a way that enables the lobes 22 of the case 1 to fit the ports 23a of the backing plate 11, and the blocking tangs 5 and 6 went through the opening 23 in the backing plate 11. Having placed the subassembly in relation to the tabletop 12 in such a manner, one needs to move the handles 8 towards the groove 18 in the case 1. Then the sliding of the blocking tangs 5 and 6 is commenced, going from port 14a along the rib 15 on the extension 14b of the grooves 14 and 16, and then the table leg system with the case 24 is automatically pressed together with the backing plate 11 and thus the tabletop 12.

In another example of a realization of the invention, the leg 17 is placed on the connecting line of the tabletop 12a and 12b in such a way that one lobe 22 of the case 1 is in port 23a of the backing plate 11 fixed to the tabletop 12a, and the other lobe 22 of the case 1 is in port 23a of the backing plate 11 fixed to tabletop 12b. In this position the lever 3 will cooperate with the pair of grooves 9, while the lever 4 will cooperate with the pair of grooves 10.

The object of the invention accordingly to the specification may be used to support the tabletop, thus constituting a stable construction of single tables, as well as that of combinations of office tables, conference tables, tables in dining-rooms or restaurants; it allows for various arrangements of tables.

1. The table leg system meant for being blocked against the tabletop or against a set of tables combined in modules, characteristic in the fact that the upper end of the table leg system is equipped with a case (1) over the assembly mechanism, perpendicular to the longitudinal axis of the leg to which the casing (24) with formed hollows (27) is screwed from the side of the tabletop and in the fact that in the case (1) there are the levers' (3) and (4) rotating axes (2) in relation to the case (1) itself, and the levers (3) and (4) are on both ends terminated with fastening, blocking tangs (5) and (6) perpendicular to the lever (3) and (4), and one of the ends of each of the levers (3) and (4) is attached to an oscillating hinged connector (7), which has a pivot handle (8) installed at the other end and the fastening, blocking tangs (5) and (6) cooperate with the pairs of formed grooves (9) and (10) in the plate (11) fixed to the underside of the tabletop (12)/tabletops (12a) (12b).

2. The table leg system as claimed in point 1, characteristic in the fact that he pairs of the formed grooves (9) and (10) are made up of the right (14) and the left (16) groove and exist in the form of a port (14a) connected on both sides along a curve with narrowed extensions (14b) where blocking ribs (15) are to be found and the grooves (14) and (16) have a common longitudinal axis which consists a curve of a radius equivalent to the radius set out by the fastening, blocking tangs (5) and (6) of the levers (3) and (4) turned around the axis (2).

3. The table leg system as claimed in point 1, characteristic in the fact that the grooves (9) and (10) are positioned symmetrically relative to the symmetry axis of the plate (11), and the axes going through the ports (14a) run at a 45-degree angle to one another.

4. The table leg system as claimed in point 1, characteristic in the fact that the fastening, blocking tangs (5) and (6) are equipped with a flange (13) in their upper part which corresponds the port (14a) in the plate (11).

5. The table leg system as claimed in point 1, characteristic in the fact that the casing (24) from the side of the tabletop (12) is of an external shape which corresponds with the shape of the case (1) and fits within the case (1).

6. The table leg system as claimed in point 1, characteristic in the fact that the case (1) has a groove (18) located underneath the free ends of the handles (8) in the position of the table leg (17) being attached to the tabletop (12), whereas the curves of the handles (8) in this position form a common ridge with the ridge of the case (1) located by the groove (18).

7. The table leg system as claimed in point 1, characteristic in the fact that the case (1) has a perpendicular, springy lobe (19) on the same side as the entry into the profile of the leg (17), and the leg (17) is made up of a profile (20) and an attached casing (21) for wires.

8. The table leg system as claimed in point 1, characteristic in the fact that on the side of the tabletop, the case (1) has two locking lips (22) which base the table leg system in relation to the tabletop (12) through ports (23) made in the plate (11).
